(19) United States
(12) Patent Application Publication
(10) Pub. No.: US 2011/0262676 A1
(43) Pub. Date: Oct. 27, 2011

(54) STRUCTURE OF COMBINED METAL CASING AND PLASTIC MEMBER

(75) Inventor: Victor Shi-Yueh Sheu, Taoyuan (TW)

(73) Assignees: Sheng-Li Hsu, Lujhou City (TW); Victor Shi-Yueh Sheu, Taoyuan (TW)

(21) Appl. No.: 12/764,956

(22) Filed: Apr. 22, 2010

(51) Int. Cl. B32B 7/12; B32B 5/02; B32B 15/08

(52) U.S. Cl. 428/41.8; 428/457; 428/138; 428/100; 428/464; 428/432; 428/221

(57) ABSTRACT

A structure of combined metal casing and plastic member comprises a metal casing, a plastic member and an adhesive tape bonded between the metal casing and the plastic member. The adhesive tape is prepared by applying an adhesive bonding agent to a narrow elongated absorptive substrate by means of coating, spray-painting or printing. By means of using the adhesive tape to bond the plastic member to the metal casing, the plastic member is firmly secured to the metal casing, simplifying rapid fabrication and reducing the product manufacturing cost.

### BACKGROUND OF THE INVENTION

(a) Field of the Invention

The present invention relates to a structure of combined metal casing and plastic member and more particularly to a structure of combined metal casing and plastic member, which uses an adhesive tape to bond a metal casing and a plastic member together, facilitating the fabrication of electronic products.

(b) Description of the Prior Art

Consumer electronic products, such as notebook computers, mobile telephones, digital audio players, portable car GPS navigation devices, etc., generally use a plastic material for the casing. However, a plastic casing has the drawback of insufficient rigidness compared to a metal casing. In order to enhance the strength, a plastic casing must have a certain wall thickness. However, increasing the wall thickness of a plastic casing for an electronic product increases the size of the electronic product. Further, the plastic casing of an electronic product imparts a barrier to heat dissipation. In order to eliminate this problem, aluminum alloy, magnesium alloy, iron alloy or other metal material may be used for making a casing for electronic product for the advantage of thin wall thickness with high structural strength, smooth and attractive surface and excellent heat dissipation property. However, in order to fasten an electronic component part (for example, PC board) to the inside of a metal casing or to fasten the front and back shells of a metal casing together with screws or by a hook joint, the metal casing must provide screw holes or hook means for installation. However, it is difficult to make screw holes or hook means on the thin wall of a metal casing.

According to conventional techniques, a glue dispenser is used to apply a glue to the metal casing at selected spots, and then one plastic member that carries a screw hole or hook is adhered to the glue at each selected spot. By means of the applied glue, plastic members are fastened to the metal casing at selected locations. However, using a glue to secure plastic members to a metal casing has low structural strength. This installation procedure is also time-consuming. Further, when fastening a screw to the screw hole of a plastic member, the plastic member may be forced to drop from the metal casing.

There is known another prior art method for forming screw holes at a metal casing. According to this method, the metal casing undergoes a surface treatment so that micro holes are formed in the surface of the metal casing. Thereafter, plastic members are molded on the surface of the metal casing by injection molding. This method enables the plastic members and the metal casing to be secured firmly together. However, the surface treatment procedure is complicated, increasing the manufacturing cost of the product. Further, because the plastic members are molded on surface of the metal casing by insert molding technique, the metal casing must be put in the insert molding mold for molding. Because one insert molding mold fits only one particular shape of metal casing, another design of insert molding mold must be used when the shape or size of the metal casing is changed, thus increasing the cost. Therefore, the aforesaid prior art method is not suitable for the fabrication of versatile electronic products to satisfy diversified and small-scale production requirements.

### SUMMARY OF THE INVENTION

The present invention has been accomplished under the circumstances in view. It is one object of the present invention to provide a structure of combined metal casing and plastic member, which uses an adhesive tape to bond a metal casing and a plastic member firmly together, thereby avoiding dropping of the plastic member from the metal casing, simplifying the fabrication and lowering the manufacturing cost.

It is another object of the present invention to provide a structure of combined metal casing and plastic member, in which a plastic member is molded on an adhesive tape by means of injection molding or pressure casting molding technology so that the plastic member can be bonded to a metal casing by the adhesive tape conveniently, thus facilitating fabrication of versatile electronic products.

To achieve these and other objects of the present invention, a structure of combined metal casing and plastic member comprises a metal casing and a plastic member bonded to the metal casing, wherein an adhesive tape is bonded in between the metal casing and the plastic member to secure the metal casing and the plastic member firmly together. The adhesive tape comprises a narrow elongated absorptive substrate and a first adhesive bonding agent applied to the narrow elongated absorptive substrate and hardened.

Further, the narrow elongated absorptive substrate of the adhesive tape is prepared from a material group consisting of soft fabric, nonwoven fabric, glass fiber and paper. The first adhesive bonding agent is applied to the narrow elongated absorptive substrate by coating, spray-painting or printing. A second adhesive bonding agent is then coated on one side of the narrow elongated absorptive substrate, and then covered with a release paper. Thus, the finished adhesive tape is rolled up into a roll and kept in the inventory for further application when desired. The metal casing can be prepared from aluminum alloy, magnesium allow, titanium alloy, iron alloy or a combination thereof. The plastic member can be molded on the adhesive tape by means of injection molding or pressure casting molding technology. Further, the plastic member can be formed with a screw hole or hook.

Due to the design of the aforesaid structure of combined metal casing and plastic member, the metal casing and the plastic member are firmly secured together by the adhesive tape, and the plastic member will not drop from the metal casing. Thus, the invention simplifies fabrication of versatile electronic products and greatly lowers the manufacturing cost of the electronic product.

### BRIEF DESCRIPTION OF THE DRAWINGS

FIG. 1 is a sectional view of a structure of combined metal casing and plastic member in accordance with the present invention.

FIG. 2 is an oblique view of the structure of combined metal casing and plastic member in accordance with the present invention.

FIG. 3 is an exploded view of the structure of combined metal casing and plastic member in accordance with the present invention (A).

FIG. 4 is an exploded view of the structure of combined metal casing and plastic member in accordance with the present invention (B).

FIG. 5 illustrates a roll of adhesive tape made according to the present invention.

FIG. 6 is a sectional view of an alternate form of the adhesive tape according to the present invention.

FIG. 7 illustrates a plurality of plastic members molded on the adhesive tape along the length according to the present invention.

FIG. 8 illustrates an individual plastic member with an attached piece of adhesive tape for bonding to a metal casing according to the present invention.

### DETAILED DESCRIPTION OF THE PREFERRED EMBODIMENTS

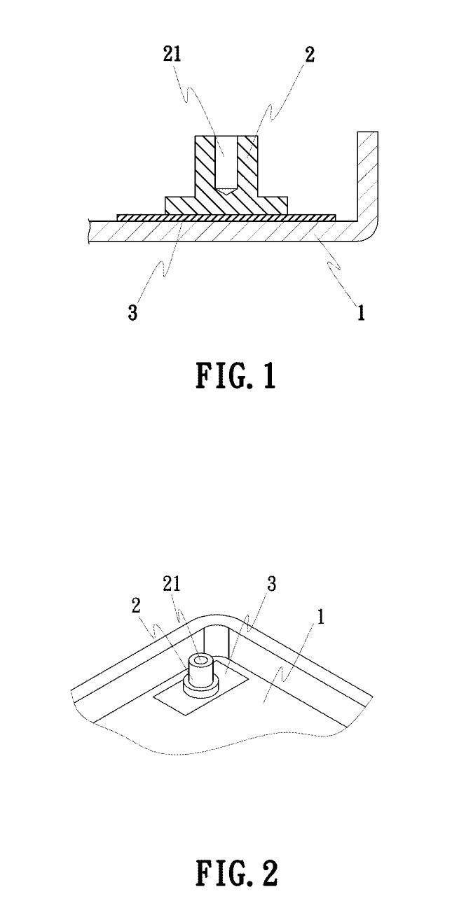

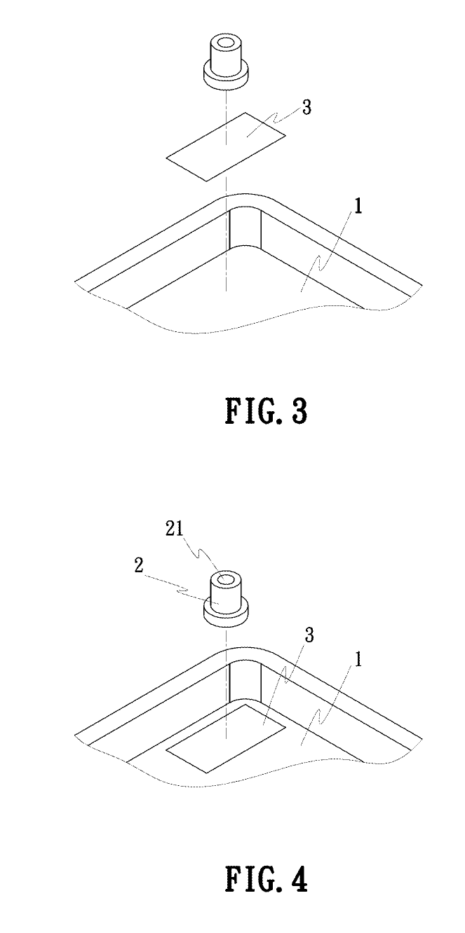

As shown in FIGS. 1, 2 and 3, a structure of combined metal casing and plastic member in accordance with the present invention comprises a metal casing 1 for an electronic product, a plastic member 2 attached to the inner surface or a selected area of the metal casing 1, and an adhesive tape 3 bonded between the metal casing 1 and the plastic member 2. The adhesive tape 3 is a narrow elongated absorptive substrate that absorbs a first adhesive bonding agent that is hardened after absorption by the narrow elongated absorptive substrate. Further, the metal casing 1 can be prepared from aluminum alloy, magnesium alloy, titanium alloy, iron alloy or a combination thereof. The plastic member 2 can be molded with the adhesive tape 3 by means of injection molding or pressure casting molding technology. Further, the plastic member 2 can be any plastic structure that carries a screw hole 21 (or a hook). Thus, a structure of combined metal casing and plastic member is obtained.

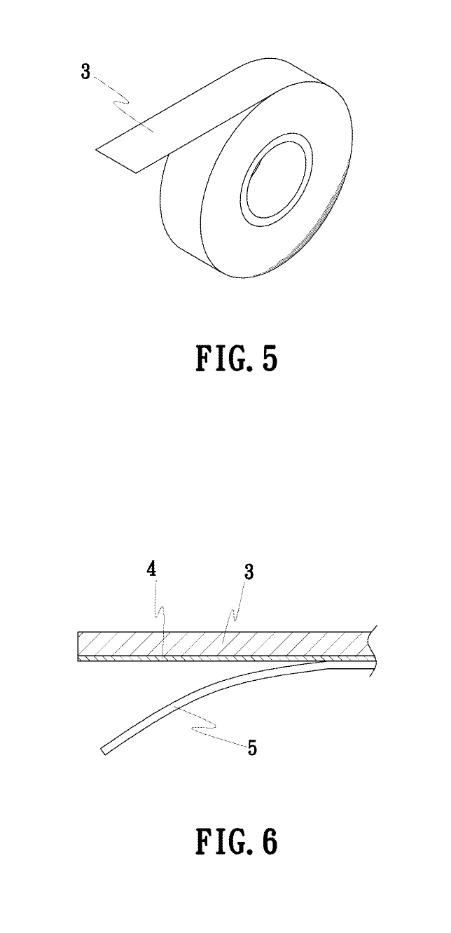

As illustrated in FIG. 5, the narrow elongated absorptive substrate of the adhesive tape 3 can be a strip of soft fabric, nonwoven fabric, glass fiber or paper. The first adhesive bonding agent of the adhesive tape 3 can be a room-temperature-curing adhesive, heat reactive adhesive, photoreactive adhesive, or a combination thereof. Thus, the prepared narrow elongated absorptive substrate (the strip of fabric, nonwoven fabric, glass fiber or paper) can absorb the first adhesive bonding agent (room-temperature-curing adhesive, heat reactive adhesive, photoreactive adhesive, or a combination thereof) and hardened, and then rolled up into a roll of adhesive tape 3 for application. When the metal casing 1 is to be bonded to the plastic member 2 together, the roll of adhesive tape 3 is pulled out for application.

Referring to FIG. 4, when the roll of adhesive tape 3 is applied to bond the metal casing 1 and the plastic member 2 together, one piece of the adhesive tape 3 is cut in a size greater than the size of the plastic member 2, and then the piece of adhesive tape 3 is attached to the inner surface or any desired area of the metal casing 1 for enabling the piece of adhesive tape 3 to be bonded to the metal casing 1 by means of a bonding, heating or light radiating technique. The piece of adhesive tape 3 can be covered with a layer of the first adhesive bonding agent again by means of coating, spray-painting or printing before attaching to the metal casing 1. After the piece of adhesive tape 3 is bonded to the metal casing 1 according to the aforesaid procedure, the metal casing 1 is put in an injection molding mold or pressure casting molding mold of an injection molding or pressure casting molding machine, for enabling the plastic member 2 to be molded on the surface of the plastic member 2 with the piece of adhesive tape 3 bonded in between the metal casing 1 and the plastic member 2.

Referring to FIG. 6, in order to enable the adhesive tape 3 to provide a self-adhesive function, a second adhesive bonding agent 4 is applied to one side of the adhesive tape 3, and then a release paper 5 is covered on the second adhesive bonding agent 4. Thus, the adhesive tape 3 can be adhered to the inner surface of any desired area of the metal casing 1 by means of the second adhesive bonding agent 4, and then the metal casing 1 is put in an injection molding mold or pressure casting mold of an injection molding or pressure casting molding machine, for enabling the plastic member 2 to be molded on the surface of the plastic member 2 with the adhesive tape 3 bonded in between the metal casing 1 and the plastic member 2.

By means of the metal casing and plastic member combination design of the present invention, the adhesive tape 3 secures the metal casing 1 and the plastic member 2 firmly together, thereby avoiding dropping of the plastic member 2 from the metal casing 1. When compared to the conventional technique of surface treatment of the metal casing and then molding a plastic member on the metal casing, the invention eliminates the complicated surface treatment procedure, thereby lowering the manufacturing cost.

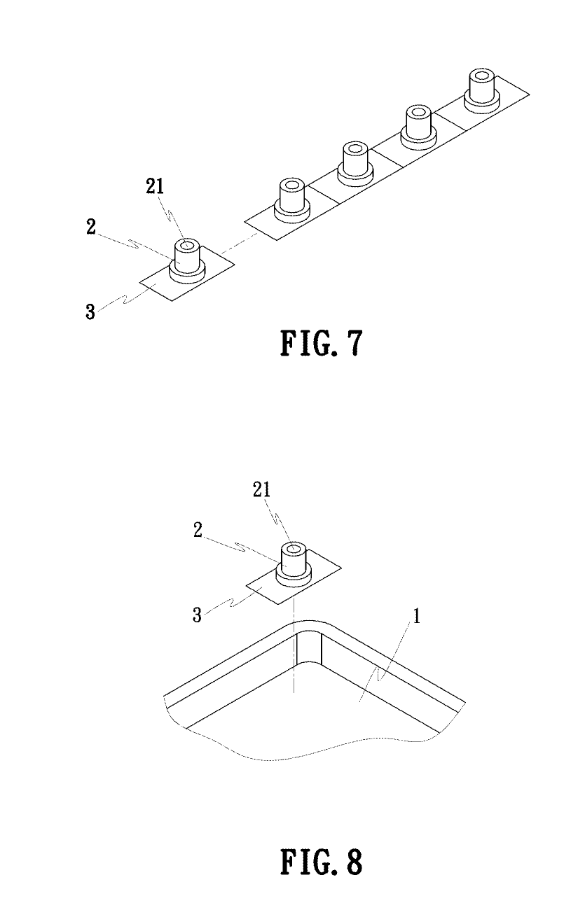

Referring to FIGS. 7 and 8, the adhesive tape 3 can be put in the injection molding mold or pressure casting molding mold to have a number of plastic members 2 to be molded on one side of the adhesive tape 3, and then the molded combination plastic members 2 and adhesive tape 3 is cut into individual pieces so that each individual plastic member 2 has a piece of adhesive tape 3 bonded thereto. By means of the first adhesive bonding agent or second adhesive bonding agent 4 of the bonded piece of adhesive tape 3, each individual plastic member 2 can be directly bonded to a respective metal casing 1 for electronic product without any further molding process, thereby simplifying the fabrication of the electronic product.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A structure of combined metal casing and plastic member, comprising a metal casing and a plastic member bonded to said metal casing, wherein an adhesive tape is bonded in between said metal casing and said plastic member to secure said metal casing and said plastic member firmly together, said adhesive tape comprising an absorptive substrate and a first adhesive bonding agent applied to said absorptive substrate.

2. The structure of combined metal casing and plastic member as claimed in claim 1, wherein said absorptive substrate comprises a material selected from a group consisting of soft fabric, nonwoven fabric, glass fiber and paper.

3. The structure of combined metal casing and plastic member as claimed in claim 1, wherein said first adhesive bonding agent is selected from a group consisting of room-temperature-curing adhesive, heat reactive adhesive, photoreactive adhesive and a combination thereof.

4. The structure of combined metal casing and plastic member as claimed in claim 1, wherein said adhesive tape further comprises a second adhesive bonding agent coated on one side thereof and a release paper detachably covered on said second adhesive bonding agent.

5. The structure of combined metal casing and plastic member as claimed in claim 1, wherein said metal casing is made from a material selected from a group consisting of aluminum alloy, magnesium alloy, titanium alloy, iron alloy and a combination thereof.

6. The structure of combined metal casing and plastic member as claimed in claim 1, wherein said plastic member is molded on said adhesive tape by injection molding technology.

7. The structure of combined metal casing and plastic member as claimed in claim 1, wherein said plastic member is molded on said adhesive tape by pressure casting molding technology.

8. The structure of combined metal casing and plastic member as claimed in claim 1, wherein said plastic member has a screw hole formed therein.

9. The structure of combined metal casing and plastic member as claimed in claim 1, wherein said plastic member has a hook formed thereon.
